(19) United States
(12) Patent Application Publication
(10) Pub. No.: US 2026/0321987 A1
(43) Pub. Date: Oct. 15, 2026

(54) ANTENNA ELEMENT AND COMMUNICATION DEVICE

(71) Applicant: Huawei Technologies Co., Ltd., Shenzhen (CN)

(72) Inventors: Wei Liu, Singapore (SG); Weihong Xiao, Dongguan (CN); Peng Luo, Singapore (SG); Ruolei Xu, Singapore (SG); Cong Wang, Singapore (SG); Jinju Wang, Dongguan (CN)

(21) Appl. No.: 19/684,006

(22) Filed: May 21, 2026

Related U.S. Application Data
(63) Continuation of application No. PCT/CN2024/129367, filed on Nov. 1, 2024.

(30) Foreign Application Priority Data
Nov. 22, 2023 (CN) 202311574098.7

(51) Int. Cl. H01Q 15/00; H01Q 9/04

(52) U.S. Cl. CPC H01Q 15/0086; H01Q 9/045

(57) ABSTRACT

This application provides an antenna element and a communication device. The antenna element includes: a substrate, where a feed network, a feed patch, and a metasurface radiator are disposed on the substrate, the feed patch and the metasurface radiator are located in a first region, and the feed network is connected to the feed patch; and a metal back cavity, where the substrate is disposed on the metal back cavity.

### CROSS-REFERENCE TO RELATED APPLICATIONS

This application is a continuation of International Application No. PCT/CN2024/129367, filed on Nov. 1, 2024, which claims priority to Chinese Patent Application No. 202311574098.7, filed on Nov. 22, 2023. The disclosures of the aforementioned applications are hereby incorporated by reference in their entireties.

### TECHNICAL FIELD

This application relates to the field of wireless technologies, and specifically, to an antenna element and a communication device.

### BACKGROUND

Antenna arraying is a common approach for implementing narrow beams and high gains. However, array antennas require complex feed networks, resulting in high costs and feed network losses. Achieving high gains by using a single antenna element is highly valuable in the wireless communication industry.

In the conventional technology, an antenna element with a controllable beam width already exists. An asymmetric radiation cavity is disposed, so that a horizontal beam width and a vertical beam width of an antenna are inconsistent, allowing for separate control of the horizontal beam width and the vertical beam width in a dual-polarized state to achieve a high gain. However, in such an antenna element, the feed structure is disposed in the radiation cavity, resulting in a complex overall antenna structure.

### SUMMARY

Embodiments of this application provide an antenna element and a communication device, to simplify a structure of the antenna element.

According to a first aspect, an antenna element is provided, including: a substrate, where a feed network, a feed patch, and a metasurface radiator are disposed on the substrate, the feed patch and the metasurface radiator are located in a first region, and the feed network is connected to the feed patch; and a metal back cavity, where the substrate is disposed on the metal back cavity.

In this embodiment provided in this application, the feed network, the feed patch, and the metasurface radiator are all integrated on the substrate, the feed patch and the metasurface radiator are located in the first region, and the feed network is connected to the feed patch. This can simplify a structure of the antenna element, implement lightweight of the antenna element, reduce complexity of manufacturing and assembling the antenna element, and lower production costs of the antenna element.

With reference to the first aspect, in some implementations of the first aspect, that the feed network is connected to the feed patch includes: at least a part of the feed network is located in the first region, and the part that is of the feed network and that is located in the first region is connected to the feed patch.

In this embodiment provided in this application, at least a part of the feed network is located in the first region, and the part that is of the feed network and that is located in the first region is connected to the feed patch, to improve feeding efficiency of the feed network to the feed patch.

With reference to the first aspect, in some implementations of the first aspect, the feed network, the feed patch, and the metasurface radiator are disposed on a same surface of the substrate.

In this embodiment provided in this application, the feed network, the feed patch, and the metasurface radiator are disposed on a same surface of the substrate, so that a structure of the antenna element can be further simplified, and the feed network, the feed patch, and the metasurface radiator can be integrally formed, to reduce manufacturing complexity and production costs.

With reference to the first aspect, in some implementations of the first aspect, the feed network, the feed patch, and the metasurface radiator are disposed on a surface that is of the substrate and that faces the metal back cavity.

In this embodiment provided in this application, the feed network, the feed patch, and the metasurface radiator are disposed on the surface that is of the substrate and that faces the metal back cavity, to reduce an overall loss of the antenna element.

With reference to the first aspect, in some implementations of the first aspect, the metasurface radiator includes a plurality of patch elements, and a projected area of the feed patch in a direction perpendicular to the substrate is different from a projected area of each of the plurality of patch elements in the direction perpendicular to the substrate.

In this embodiment provided in this application, the projection area of the feed patch in the direction perpendicular to the substrate is different from the projected area of the patch element of the metasurface radiator in the direction perpendicular to the substrate, so that radiation field distribution of the antenna element in the vertical direction can be adjusted, a directivity coefficient can be improved, and a beam shape of an incident radiation pattern in the vertical direction can be adjusted and controlled, for example, a beam null position and depth.

With reference to the first aspect, in some implementations of the first aspect, the metasurface radiator includes a plurality of first patch elements and a plurality of second patch elements, the plurality of first patch elements and the plurality of second patch elements are respectively disposed in regions on two sides of the feed patch in the first region, and a projected area of each of the plurality of first patch elements in the direction perpendicular to the substrate is different from a projected area of each of the plurality of second patch elements in the direction perpendicular to the substrate.

With reference to the first aspect, in some implementations of the first aspect, the plurality of first patch elements and the plurality of second patch elements are respectively disposed in regions on two sides of the feed patch in a direction of a first edge of the antenna element.

In this embodiment provided in this application, projected areas of a single first patch element and a single second patch element that are located in regions on two sides of the feed patch are different in the direction perpendicular to the substrate, so that radiation field distribution of the antenna element in the vertical direction can be adjusted, a directivity coefficient can be improved, and a beam shape of an incident radiation pattern in the vertical direction can be adjusted and controlled.

With reference to the first aspect, in some implementations of the first aspect, the metasurface radiator includes a plurality of patch elements, the plurality of patch elements are distributed in different regions on the substrate, and a first gap exists between the feed patch and an adjacent patch element.

In this embodiment provided in this application, the first gap exists between the feed patch and the adjacent patch element, so that the feed patch can feed the metasurface radiator by coupling through the first gap.

With reference to the first aspect, in some implementations of the first aspect, widths of first gaps between the feed patch and patch elements located in regions on two sides of the feed patch are different.

In this embodiment provided in this application, the widths of the first gaps between the feed patch and the patch elements located in regions on two sides of the feed patch are different, so that impedance matching of the antenna element can be adjusted and controlled.

With reference to the first aspect, in some implementations of the first aspect, the metasurface radiator includes a plurality of patch elements, and a second gap exists between two adjacent patch elements in the plurality of patch elements.

In this embodiment provided in this application, the second gap exists between two adjacent patch elements, so that the plurality of patch elements can feed each other by coupling through the second gap.

With reference to the first aspect, in some implementations of the first aspect, widths of second gaps of patch elements located in regions on two sides of the feed patch are different.

In this embodiment provided in this application, the widths of the second gaps of the patch elements located in the regions on the two sides of the feed patch are different, so that a beam shape of an incident radiation pattern of the antenna element in the vertical direction can be adjusted and controlled.

With reference to the first aspect, in some implementations of the first aspect, a width of the first gap is different from a width of the second gap.

In this embodiment provided in this application, the width of the first gap is different from the width of the second gap, so that a beam shape of an incident radiation pattern of the antenna element in the vertical direction can be adjusted and controlled.

With reference to the first aspect, in some implementations of the first aspect, the metal back cavity includes a first metal plate, the first metal plate is a bottom plate of the metal back cavity, and the first metal plate is a grounding structure of the feed network.

In this embodiment provided in this application, the bottom plate of the metal cavity is used as the grounding structure of the feed network, so that a structure of the antenna element can be simplified.

With reference to the first aspect, in some implementations of the first aspect, the metal back cavity includes a first metal plate and a second metal plate, the first metal plate is a bottom plate of the metal back cavity, the second metal plate is disposed above the first metal plate, and the second metal plate is a grounding structure of the feed network.

In this embodiment provided in this application, the metal back cavity includes the first metal plate and the second metal plate, and the second metal plate is used as the grounding structure of the feed network, so that the feed network can be better grounded when the metal back cavity is thick.

With reference to the first aspect, in some implementations of the first aspect, the second metal plate includes a main part and an extension part, the main part is fastened to the metal back cavity, and the extension part and the main part are disposed at an included angle.

In this embodiment provided in this application, the second metal plate includes the main part and the extension part, and the main part and the extension part are disposed at an included angle, so that a shape of the second metal plate can adapt to a shape of the feed network, and impedance matching is easily implemented.

With reference to the first aspect, in some implementations of the first aspect, a gap exists between the first region and the metal back cavity.

In this embodiment provided in this application, a gap exists between the first region and the metal back cavity, so that cross polarization discrimination of the antenna element can be adjusted.

With reference to the first aspect, in some implementations of the first aspect, there is one or more feed patches, and the one or more feed patches are disposed on a same surface of the substrate in the direction of the first edge of the antenna element.

In this embodiment provided in this application, the antenna element in which one or more feed patches are disposed in the direction of the first edge of the antenna element can be equivalent to a conventional antenna element that includes more feed patches, to implement same radiation effect. For example, an antenna element that includes one feed patch can be equivalent to a conventional antenna element that includes two feed patches, so that a structure of the antenna element can be simplified. In addition, one or more feed patches need to be fed by only one or two feed points, and a feed network structure can be simplified. The one or more feed patches are disposed on a same surface of the substrate in the vertical direction, so that the antenna element can be easily manufactured.

With reference to the first aspect, in some implementations of the first aspect, an edge of the feed patch includes an opening part, and/or the feed patch is in a truncated-corner structure.

In this embodiment provided in this application, the edge of the feed patch includes the opening part, and/or the feed patch is in the truncated-corner structure, to further optimize port isolation and cross polarization discrimination in the antenna element.

With reference to the first aspect, in some implementations of the first aspect, a length of the first edge of the antenna element is greater than or equal to an operating wavelength of the antenna element.

In this embodiment provided in this application, the length of the first edge of the antenna element is greater than or equal to the operating wavelength of the antenna element, so that a beam width of the antenna element in the vertical direction can be significantly compressed, and cross polarization discrimination of the antenna element can be adjusted.

With reference to the first aspect, in some implementations of the first aspect, a length of a second edge of the antenna element is less than or equal to 0.5 times the operating wavelength of the antenna element.

In this embodiment provided in this application, the length of the second edge of the antenna element is less than or equal to 0.5 times the operating wavelength of the antenna element, so that the antenna element can maintain a wide beam width in a horizontal direction, and cross polarization discrimination of the antenna element is adjusted, to facilitate arraying of the antenna element in the horizontal direction.

According to a second aspect, a communication device is provided. The communication device includes one or more antenna elements according to any one of the first aspect or the implementations of the first aspect.

### BRIEF DESCRIPTION OF THE DRAWINGS

FIG. 1 is a diagram of an application scenario of an antenna system according to an embodiment of this application;

FIG. 2 is a diagram of a three-dimensional structure of an antenna element according to an embodiment of this application;

FIG. 3 is a diagram of a structure of a substrate according to an embodiment of this application;

FIG. 4 is a diagram of a structure of a substrate according to an embodiment of this application;

FIG. 5 is a diagram of a structure of a substrate according to an embodiment of this application;

FIG. 6 is a diagram of a top view of a structure of an antenna element according to an embodiment of this application;

FIG. 7A, FIG. 7B, and FIG. 7C are diagrams of a top view of a structure of an antenna element according to an embodiment of this application;

FIG. 8A and FIG. 8B are diagrams of a top view of a structure of an antenna element according to an embodiment of this application;

FIG. 9 is a diagram of a side view of a structure of an antenna element according to an embodiment of this application; and

FIG. 10A, FIG. 10B, FIG. 10C, and FIG. 10D are diagrams of a three-dimensional structure of a metal back cavity according to an embodiment of this application.

### DETAILED DESCRIPTION OF ILLUSTRATIVE EMBODIMENTS

The following describes technical solutions of this application with reference to accompanying drawings.

Reference to “an embodiment”, “some embodiments”, or the like described in this specification means that one or more embodiments of this application include a specific feature, structure, or characteristic described with reference to the embodiments. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner.

The terms “include”, “have”, and their variants all mean “include but are not limited to”, unless otherwise specifically emphasized in another manner.

In embodiments of this application, “first”, “second”, and the like are merely intended to indicate that a plurality of objects are different. For example, a first side wall and a second side wall are merely used to represent different side walls of a metal cavity. The terms should impose no impact on the side walls and quantities thereof. “First”, “second”, and the like described above should not impose any limitation on embodiments of this application.

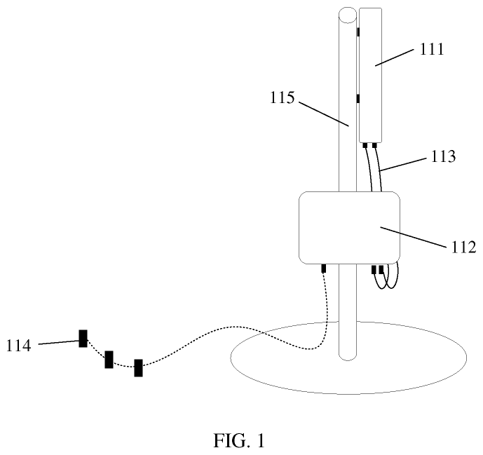

FIG. 1 is a diagram of an application scenario according to an embodiment of this application. An antenna 111 may be disposed on a pole 115, and is fastened to the pole 115. The pole 115 may be fastened to the ground. The antenna 111 may be configured to receive and send an antenna signal. The antenna 111 may include the antenna element described below. The antenna 111 may include one or more antenna elements. A plurality of antenna elements may alternatively be arranged in an array to form one or more antenna arrays. Frequencies of the antenna elements in the antenna arrays may be the same or different. The antenna 111 may be connected to a remote radio unit (RRU) 112 through a feeder 113, and the RRU 112 may be connected to a baseband unit (BBU) 114 through an optical fiber.

In addition, the antenna 111 may also be integrated with the remote radio unit 112. For example, the antenna 111 and the remote radio unit 112 are a part of an active antenna unit (AAU). Alternatively, the antenna 111 may be a part of a radio unit (RU). This is not limited in this application.

The antenna element provided in this embodiment of this application may be used in the foregoing antenna 111. The following describes in detail a structure of the antenna element provided in this embodiment of this application with reference to the accompanying drawings.

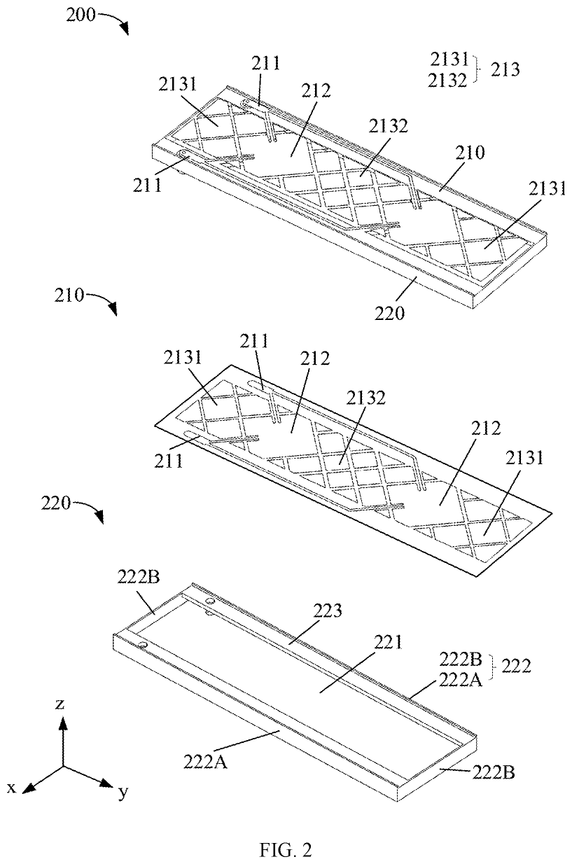

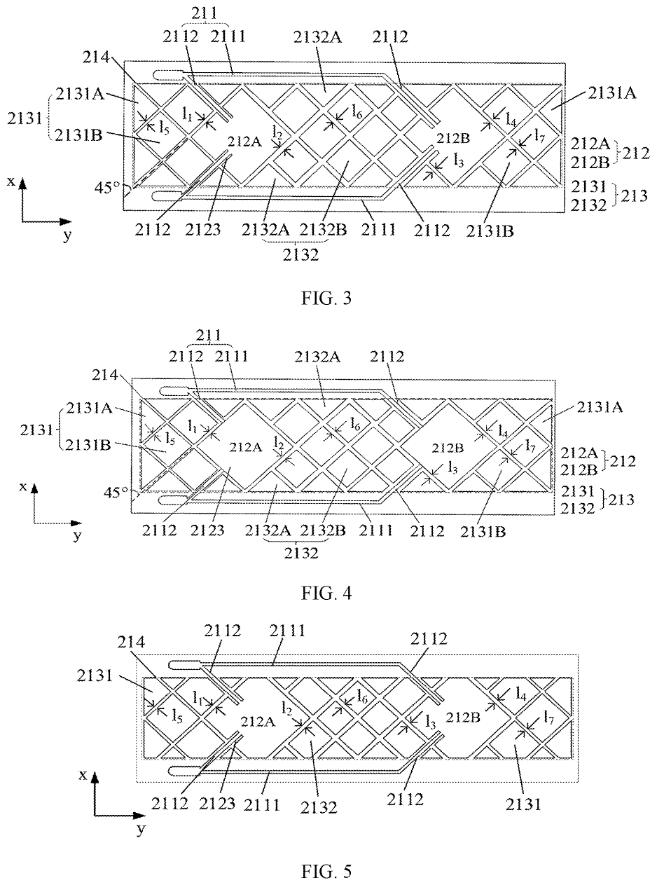

FIG. 2 is a diagram of a three-dimensional structure of an antenna element according to an embodiment of this application. FIG. 3 to FIG. 5 are diagrams of a surface structure of a substrate 210 in the antenna element. The antenna element 200 may include the substrate 210 and a metal back cavity 220, and the substrate 210 may be disposed on the metal back cavity 220.

Refer to the structures described in FIG. 2 to FIG. 5. The substrate 210 may be a printed circuit board (PCB). A feed network 211, a feed patch 212, and a metasurface radiator 213 may be disposed on the substrate 210. The feed patch 212 and the metasurface radiator 213 may be located in a first region 214. Refer to a region identified by a dashed box in FIG. 3. A shape of the first region 214 may be, for example, a rectangle shown in the figure. A size of the rectangular first region 214 may be less than a size of the substrate 210, to reserve space for disposing the feed network 211. A part of the feed network 211 may be disposed outside the first region 214, and a part of the feed network 211 may be disposed inside the first region 214. The part disposed inside the first region 214 may be connected to the feed patch 212.

For example, the feed network 211 may include a first part 2111 and a second part 2112. The first part 2111 may be located outside the first region 214. The first part 2111 may be in a strip shape and may be disposed in a vertical direction. The vertical direction may be a direction of a y-axis shown in the figure. The second part 2112 and the first part 2111 may be disposed at an included angle, for example, 45°. One end of the second part 2112 may be fastened to the first part 2111, and the other end may extend into the first region 214. When the second part 2112 extends into the first region 214, the second part 2112 may be perpendicular to an edge that is of the feed patch 212 and that is close to the second part 2112, to implement ±45° polarization of the antenna element.

The feed network 211 may include two feed ports, and the two feed ports may be separately disposed on two sides of the first region 214 in a direction of an x-axis shown in the figure. In other words, the feed network 211 may include two parts disposed on two sides of the first region 214, and each part corresponds to one feed port. In addition, the two parts of the feed network 211 that are located on two sides of the first region 214 may have a same structure. The two parts of the feed network 211 that are located on two sides of the first region 214 may each include one first part 2111. The first part 2111 may be connected to one or more second parts 2112, and the one or more second parts 2112 may be electrically connected to one or more feed patches 212. The two feed ports of the feed network 211 may feed separately, or may feed simultaneously. When a polarization mode of excitation of one feed port is +45° polarization, a polarization mode of excitation of the other feed port may be −45° polarization. Operating modes of parts that are above and below the first region 214 and in which the feed network 211 is located may be symmetrical. When the two feed ports of the feed network 211 are excited simultaneously, the antenna element may form ±45° dual polarization. When one of the feed ports is excited, a polarization mode of the antenna element may be +45° or −45° single polarization. Alternatively, the feed network 211 may include only one feed port, that is, may include only a part above the first region 214 shown in the figure, or may include only a part below the first region 214. In this example, when the feed port is excited, a polarization mode of the antenna element may be +45° or −45° single polarization.

A quantity of second parts 2112 in the feed network 211 may be the same as a quantity of feed patches 212, and each second part 2112 may be connected to one feed patch 212. A signal on the feed network 211 may be input from a feed port, and is transmitted to the feed patch 212 through the first part 2111 and the second part 2112, to implement feeding to the feed patch 212.

The feed network 211 may be directly electrically connected to the feed patch 212. For example, as shown in FIG. 3, the feed patch 212 may be in a square structure, and the feed patch 212 may include a slot 2123. The slot 2123 may extend to a center of the feed patch 212 in a direction perpendicular to an edge of the feed patch 212. The second part 2112 of the feed network 211 may extend into the first region 214 and extend into the slot 2123, and contact the feed patch 212 at a tail end of the slot 2123, to implement electrical connection between the feed network 211 and the feed patch 212. Alternatively, the feed patch 212 may not include the slot 2123, and is in a complete square structure. As shown in FIG. 4, the second part 2112 may be connected to an edge part of the feed patch 212.

Alternatively, the feed network 211 may not be in direct contact with the feed patch 212, but may be coupled to the feed patch 212 through a gap, and the feed patch is excited through the gap (not shown in the figure). For example, when the feed patch 212 includes the slot 2123, the second part 2112 of the feed network 211 may extend into the slot 2123, and may be spaced apart from the feed patch 212, so that a gap is formed between the second part 2112 and the feed patch 212. The feed network 211 feeds the feed patch 212 through the gap, and a depth to which the second part 2112 extends into the feed patch 212 may be adjusted based on an impedance matching status. Alternatively, when the feed patch 212 does not include the slot 2123, the second part 2112 may be disposed outside the feed patch 212. In other words, a projection of the second part 2112 in a direction perpendicular to the substrate 210 does not overlap a projection of the feed patch 212 in the direction perpendicular to the substrate 210, and the second part 2112 may be spaced apart from the feed patch 212 to form a gap. The feed network 211 may feed the feed patch 212 by coupling through the gap.

The feed network 211, the feed patch 212, and the metasurface radiator 213 may be disposed on a same surface of the substrate 210. When the substrate 210 is disposed on the metal back cavity 220, the surface that is of the substrate 210 and that includes the feed network 211, the feed patch 212, and the metasurface radiator 213 may face the metal back cavity 220.

Alternatively, the feed network 211, the feed patch 212, and the metasurface radiator 213 may be located between the substrate 210 and the metal back cavity. The surface that is of the substrate 210 and that includes the feed network 211, the feed patch 212, and the metasurface radiator 213 faces the metal back cavity 220, to form an air cavity together with the metal back cavity 220. Compared with a cavity filled by a dielectric, an overall loss of the antenna element can be reduced.

The feed patch 212 may be a main feed source of the antenna element, and the feed network 211 may excite the feed patch 212. Further, the feed patch 212 may excite the metasurface radiator 213 by coupling, so that the feed patch 212 and the metasurface radiator 213 can perform resonance radiation in combination with the metal back cavity 220.

It should be noted that the surface that is of the substrate 210 and that includes the feed network 211, the feed patch 212, and the metasurface radiator 213 may alternatively face away from the metal back cavity 220. Alternatively, the feed network 211, the feed patch 212, and the metasurface radiator 213 may not be disposed on a same surface of the substrate 210. For example, the feed network 211 may be disposed on a surface that is of the substrate 210 and that faces the metal back cavity 220, and the feed patch 212 and the metasurface radiator 213 may be disposed on a surface that is of the substrate 210 and that faces away from the metal back cavity 220. When there are a plurality of metasurface radiators 213, the plurality of metasurface radiators 213 may also be disposed on different surfaces of the substrate 210. Similarly, when there are a plurality of feed patches 212, the plurality of feed patches 212 may also be disposed on different surfaces of the substrate 210. This is not limited in this application.

In this embodiment provided in this application, the feed network 211, the feed patch 212, and the metasurface radiator 213 are all integrated on the substrate 210, so that a structure of the antenna element can be simplified. When the feed network 211, the feed patch 212, and the metasurface radiator 213 are disposed on a same surface of the substrate 210, the feed network 211, the feed patch 212, and the metasurface radiator 213 can be formed at a time. For example, structures of the feed network 211, the feed patch 212, and the metasurface radiator 213 shown in the figure may be directly obtained on a same metal plate by using a process such as cutting, so that manufacturing complexity and production costs of the antenna element can be reduced. The feed network 211, the feed patch 212, and the metasurface radiator 213 are located on the surface that is of the substrate 210 and that faces the metal back cavity 220, so that an air cavity is formed with the metal back cavity 220, to reduce a transmission loss of the entire antenna element, and the feed network 211 and the metal back cavity 220 can provide a condition for forming an air-suspended microstrip line structure, to reduce a transmission loss of the feed network 211. In addition, because the metasurface radiator 213 has an electromagnetic bandgap characteristic for a surface wave, surface wave propagation in an operating frequency band of an antenna can be suppressed, to suppress antenna mutual coupling caused by surface wave propagation, implement an antenna self-decouple function, and improve isolation between antenna elements.

FIG. 3 to FIG. 5 are diagrams of a structure of a surface of the substrate 210. The feed patch 212 in FIG. 3 and FIG. 4 is a square structure. An included angle between an edge of the square feed patch 212 and an edge of the substrate 210 may be, for example, 45°, so that the antenna element can implement ±45° polarization. There may be a plurality of feed patches 212, for example, two feed patches 212A and 212B shown in the figure. When there are a plurality of feed patches 212, the plurality of feed patches 212 may be disposed in a vertical direction, and may be disposed on a central axis of the substrate 210. The vertical direction is a direction of a first edge of the antenna element. The first edge of the antenna element may be any edge of the antenna element. When the antenna element is an asymmetric antenna element, the first edge may be a direction of an edge with a large size of the antenna element, that is, may be a direction of the y-axis shown in the figure. In addition, there may be a distance between two adjacent feed patches 212, to dispose the metasurface radiator 213.

The metasurface radiator 213 may include a plurality of patch elements, and the plurality of patch elements may be disposed on two sides of the feed patch 212 in the vertical direction. For example, as shown in FIG. 3 or FIG. 4, when there are two feed patches 212, the patch elements may include patch elements 2131 disposed in regions at two ends of the substrate 210 and patch elements 2132 located in a region between the feed patch 212A and the feed patch 212B (or referred to as a middle region of the substrate 210), and there may be a plurality of patch elements 2131 and a plurality of patch elements 2132. The patch elements 2131 located in the regions at two ends may also be referred to as first patch elements 2131, and the patch elements 2132 located in the middle region may also be referred to as second patch elements 2132. Alternatively, the patch elements 2131 located in the regions at the two ends may be referred to as second patch elements, and the patch elements 2132 located in the middle region may be referred to as first patch elements. Names of the patch elements are not limited in this application. In this embodiment of this application, an example in which the patch elements 2131 located in the regions at two ends are referred to as the first patch elements 2131, and the patch elements 2132 located in the middle region are referred to as the second patch elements 2132 is used to describe a structure of the metasurface radiator.

A projected area of each of the plurality of patch elements on the substrate 210 in the direction perpendicular to the substrate 210 may be different from a projected area of each feed patch 212 on the substrate 210 in the direction perpendicular to the substrate 210, or a size of a patch element may be different from a size of the feed patch 212.

For example, the patch element may alternatively be in a square structure. An edge length of the square patch element may be less than an edge length of the square feed patch 212, and both edge lengths of the patch elements 2131 located in the regions at two ends of the substrate 210 and the patch elements 2132 located in the middle region may be less than an edge length of the feed patch 212A or an edge length of the feed patch 212B, so that the projected area of the patch element in the direction perpendicular to the substrate 210 is less than the projected area of the feed patch 212 in the direction perpendicular to the substrate 210. Alternatively, the edge length of the patch element may be greater than an edge length (not shown in the figure) of the feed patch 212, so that the projected area of the patch element in the direction perpendicular to the substrate 210 is greater than the projected area of the feed patch 212 in the direction perpendicular to the substrate 210. This is not limited in this application.

When the antenna element is excited, the feed patch 212 and the metasurface radiator 213 perform radiation together with the metal back cavity 220. The projected areas of the feed patch 212 and the patch elements of the metasurface radiator 213 in the direction perpendicular to the substrate 210 are different, so that radiation field distribution of the antenna element in the vertical direction can be adjusted, a directivity coefficient can be improved, and a beam shape of an incident radiation pattern in the vertical direction can be adjusted and controlled, for example, a beam null position and depth.

Adjacent edges of the feed patch 212 and a patch element that are adjacent may be parallel to each other. In other words, a 45° included angle may be formed between a plurality of patch elements and an edge of the substrate 210. In addition, a first gap may exist between the feed patch 212 and an adjacent patch element, and the feed patch 212 may feed the metasurface radiator 213 by coupling through the first gap.

In some embodiments, the plurality of first patch elements 2131 and the plurality of second patch elements 2132 are respectively located in the regions at the two ends and the middle region of the substrate 210. In other words, the plurality of first patch elements 2131 and the plurality of second patch elements 2132 may be respectively located in regions on two sides of the feed patch 212A and the feed patch 212B in a y-axis direction. A projected area of each of the plurality of first patch elements 2131 in the direction perpendicular to the substrate 210 may be different from a projected area of each of the plurality of second patch elements 2132 in the direction perpendicular to the substrate 210. As shown in FIG. 3 to FIG. 5, a size of a single first patch element 2131 may be greater than a size of a single second patch element 2132. For example, an edge length of the single first patch element 2131 may be greater than the size of the single second patch element 2132, so that a projected area of the single first patch element 2131 in the direction perpendicular to the substrate 210 can be greater than a projected area of the single second patch element 2132 in the direction perpendicular to the substrate 210. Alternatively, the edge length of the single first patch element 2131 may be less than the edge length of the single second patch element 2132, so that the projected area of the single first patch element 2131 in the direction perpendicular to the substrate 210 can be less than the projected area of the single second patch element 2132 in the direction perpendicular to the substrate 210. For another example, a first patch element located on a left side of the feed patch 212A and a first patch element 2131 located on a right side of the feed patch 212B may have different sizes.

Further, projected areas of the plurality of patch elements located in a same region in the direction perpendicular to the substrate 210 may also be different. For example, in the middle region of the substrate 210, an edge length of a patch element close to the feed patch 212A may also be different from an edge length of a patch element close to the feed patch 212B. For another example, to avoid the feed network, patch elements in a same region may be truncated from a square structure to form a shape such as a trapezoid, so that projected areas of the patch elements in the same region can also be different.

The plurality of patch elements are distributed in different regions on the substrate 210, and projected areas of single patch elements in different regions in the direction perpendicular to the substrate 210 are different, so that radiation field distribution of the antenna element in the vertical direction can be adjusted, a directivity coefficient can be improved, and a beam shape of an incident radiation pattern in the vertical direction can be adjusted and controlled.

It should be noted that the plurality of patch elements of the metasurface radiator 213 shown in the figure are respectively disposed in regions on two sides of the feed patch 212 in the y-axis direction, and patch elements may alternatively be disposed on two sides of the feed patch 212 in an x-axis direction shown in the figure. The patch elements are disposed on two sides of the feed patch 212 in the x-axis direction. That is, the patch elements may be respectively disposed above and below the first region identified by the dashed-line box in FIG. 3 to FIG. 5. For example, in the antenna elements shown in FIG. 3 to FIG. 5, patch elements on a left side of the feed patch 212A may be further arranged in a negative direction of the x-axis and a positive direction of the x-axis, and projected areas of the patch elements on the left side of the feed patch 212A may be the same in the direction perpendicular to the substrate. Patch elements on a right side of the feed patch 212A may also be further arranged in the negative direction of the x-axis and the positive direction of the x-axis, and projected areas of the patch elements located on the right side of the feed patch 212A in the direction perpendicular to the substrate may be the same. A disposition status of patch elements around the feed patch 212B may be similar to that of the feed patch 212A. When the patch elements are also disposed on two sides of the feed patch 212 in the x-axis direction, a location of the feed network 211 may correspondingly move in the x-axis direction, a part of the feed network 211 above the first region 214 may move in the negative direction of the x-axis, and a part of the feed network 211 below the first region 214 may move in the negative direction of the x-axis, so that a projection of the first part 2111 of the feed network 211 in the direction perpendicular to the substrate 210 does not overlap a projection of a region enclosed by the patch elements and the feed patch 212 in the direction perpendicular to the substrate 210.

In some embodiments, projected areas of the plurality of patch elements of the metasurface radiator 213 in the direction perpendicular to the substrate 210 may alternatively be the same.

It should be noted that, in this embodiment of this application, the patch element of the metasurface radiator 213 shown in FIG. 3 to FIG. 5 may include an edge patch element and an internal patch element. Any edge of the edge patch element is close to any edge of the rectangular first region 214, and the internal patch element is located in an internal region of four edges enclosed by edge patch elements. For example, the patch elements 2131 located in the regions at the two ends of the substrate 210 include an edge patch element 2131A and an internal patch element 2131B, and the patch elements 2132 located in the middle region of the substrate 210 include an edge patch element 2132A and an internal patch element 2132B. The internal patch element may be in a square structure, and the edge patch element may be in a triangular structure, to adapt to a shape of the substrate 210 and make full use of surface space of the substrate 210. In this example, that projected areas of a single patch element 2131 and a single patch element 2132 in the direction perpendicular to the substrate 210 are the same may be that projected areas of a single internal patch element 2131B and a single internal patch element 2132B in the direction perpendicular to the substrate are the same. Alternatively, the metasurface radiator 213 may include only internal patch elements, that is, may include only the patch element in the square structure in FIG. 3 to FIG. 5. In this case, that projected areas of a single patch element 2131 and a single patch element 2132 in the direction perpendicular to the substrate 210 are the same may be that projected areas of any two patch elements of the metasurface radiator 213 in the direction perpendicular to the substrate 210 may be the same.

When the patch elements of the metasurface radiator 213 are distributed in different regions on the substrate 210, first gaps are formed between the feed patch 212 and the patch elements on two sides of the feed patch 212, and widths of the first gaps formed between the feed patch 212 and the patch elements on two sides of the feed patch 212 may be different. For example, a width l₁ of a first gap formed between the feed patch 212A and a patch element on a left side of the feed patch 212A may be different from a width l₂ of a first gap formed between the feed patch 212A and a patch element on a right side of the feed patch 212A. A width l₃ of a first gap formed between the feed patch 212B and a patch element on a left side of the feed patch 212A may also be different from a width l₄ of a first gap formed between the feed patch 212A and a patch element on a right side of the feed patch 212B. The width of the first gap may be a distance between two adjacent edges of the feed patch 212 and an adjacently disposed patch element. The widths of the first gaps formed between the feed patch 212 and the patch elements located on two sides of the feed patch 212 are different, and impedance matching of the antenna elements can be adjusted and controlled.

Alternatively, the widths of the first gaps formed between the feed patch 212 and the patch elements on two sides of the feed patch 212 may be the same, provided that it is ensured that the antenna element can perform coupled-feeding and radiate an electromagnetic wave through the first gap. This is not limited in this application.

In the plurality of patch elements of the metasurface radiator 213, a second gap may exist between any two adjacent patch elements, and the metasurface radiator 213 may perform coupled-feeding and radiate an electromagnetic wave through the second gap.

When the projected areas of the patch element located in the regions at the two ends and the patch element located in the middle region in the direction perpendicular to the substrate 210 are the same, widths of second gaps formed between adjacent patch elements may also be the same, and the width of the second gap may be a distance between two adjacent edges that are of two adjacent patch elements. When the projected areas of the patch element located in the regions at the two ends and the patch element located in the middle region in the direction perpendicular to the substrate 210 are the same, the widths of the second gaps formed between the two adjacent patch elements may alternatively be different. For example, the first patch elements located in the regions at the two ends may be arranged compactly, to have a small width of the second gap, and the second patch elements located in the middle region may be arranged sparsely, to have a large width of the second gap. As shown in FIG. 3, a width of a second gap l₅ may be less than a width of a second gap l₆, and a width of a second gap l₇ may also be less than the width of the second gap l₆. The width of the second gap l₅ may be the same as or different from the width of the second gap l₇. Second gaps between patch elements of the metasurface radiator 213 located in a same region may also be different. For example, different arrangement compactness degrees are set in a same region. A beam shape of an incident radiation pattern in the vertical direction of the antenna element can be adjusted and controlled by adjusting and controlling the width of the second gap.

Similarly, when projected areas of any first patch element 2131 and any second patch 2132 that are located in regions on two sides of the feed patch 212A or 212B in the direction perpendicular to the substrate 210 are different, a width of a second gap formed between two adjacent first patch elements 2131 in the plurality of first patch elements 2131 may also be different from a width of a second gap formed between two adjacent second patch elements in the plurality of second patch elements 2132. For example, when a projected area of any first patch element 2131 in the direction perpendicular to the substrate 210 is greater than a projected area of any second patch element 2132 in the direction perpendicular to the substrate 210, a width of a second gap formed between two adjacent first patch elements 2131 in the plurality of first patch elements 2131 may be less than a width of a second gap formed between two adjacent second patch elements 2132 in the plurality of second patch elements 2132.

Widths of second gaps between patch elements located in different regions are different, so that a beam shape of an incident radiation pattern of the antenna element in the vertical direction can be further adjusted and controlled.

Further, the width of the first gap may be different from the width of the second gap, to further adjust and control a beam shape of the incident radiation pattern of the antenna element in the vertical direction. The width of the first gap may also be the same as the width of the second gap, provided that the antenna element can radiate an electromagnetic wave through the first gap and the second gap.

Still refer to the structure shown in FIG. 5. Similar to the edge patch element of the metasurface radiator 213, to adapt to a shape and a structure of the substrate 210, when a size of the feed patch 212 is large, that is, when an edge length of the feed patch 212 is large, the feed patch 212 may be in a truncated-corner structure. For example, a corner is truncated at a location that is of the square feed patch 212 and that is close to an edge of the substrate 210 shown in FIG. 3 or FIG. 4, to obtain the feed patch 212 in the truncated-corner structure shown in FIG. 5. Both corners that are of the feed patch 212 and that are close to upper and lower edges of the substrate 210 may be truncated. That is, two corners of the feed patch 212 in the x-axis direction may be truncated. Sizes of the two truncated corners of the feed patch 212 may be the same, or may be different. The feed patch 212 is in a truncated-corner structure, and can adjust a current path of the feed patch 212, to further optimize polarization isolation and polarization purity in the antenna element.

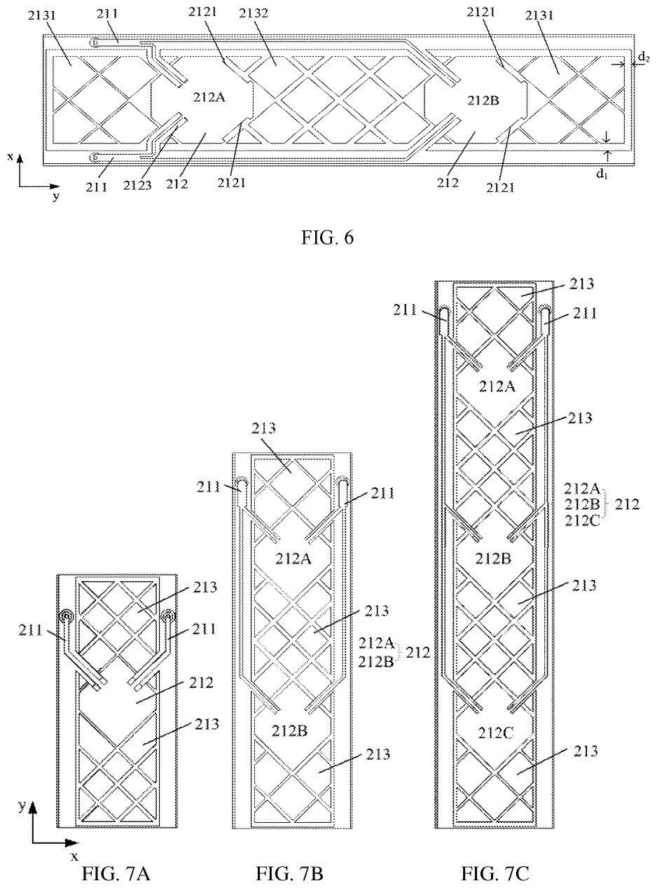

In the feed patch 212, not only two corners in the x-axis direction may be truncated, but also two corners in the y-axis direction may be truncated. As shown in FIG. 6, on the basis of the square feed patch 212 shown in FIG. 3 or FIG. 4, all four corners of the square feed patch 212 may be truncated, to form a truncated-corner structure shown in FIG. 6, so as to further adjust symmetry of the feed patch. For example, sizes and shapes of the four truncated corners of the feed patch 212 may be the same, so that the feed patch 212 may be not only horizontally symmetrical and vertically symmetrical, but also rotationally symmetrical, to further optimize polarization isolation and polarization purity in the antenna element.

It should be noted that sizes and shapes of the four truncated corners of the feed patch 212 may alternatively be different, and the sizes of the truncated corners may be adjusted based on a port isolation requirement and polarization purity in the antenna element.

Still refer to the structure shown in FIG. 6. An edge of the feed patch 212 may further include an opening part 2121. For example, a rectangle may be truncated at an edge of the square feed patch 212 shown in FIG. 3 or FIG. 4 to form the opening part 2121. A length of the opening part 2121 may be a size of a long edge of the rectangle, and the length of the opening part 2121 may be less than the edge length of the feed patch 212. When the feed network 211 is electrically connected to the feed patch 212, the opening part 2121 may be disposed on an edge that is of the feed patch 212 and that is away from the feed network 211. The opening part 2121 may be disposed on edge regions of two edges that are of the feed patch 212 and that are away from the feed network 211, or may be disposed only on any one (not shown in the figure) of the two edges that are of the feed patch 212 and that are away from the feed network 211. The feed patch 212 includes the opening part 2121, so that port isolation and polarization purity in a dual-polarized antenna element can be further optimized.

In this embodiment provided in this application, the feed patch 212 may include only truncated corners but not the opening part 2121, or may include only the opening part 2121 but not truncated corners, or may include both the truncated corners and the opening part 2121. This is not limited in this application.

FIG. 7A, FIG. 7B, and FIG. 7C are diagrams of a top view of a structure of an antenna element according to an embodiment of this application. When a size of a long edge of the substrate 210 is small, that is, when a size of the substrate 210 is small in a y-axis direction shown in the figure, there may be one feed patch 212, as shown in FIG. 7A. Correspondingly, there may also be one second part 2112 of the feed network 211. The feed patch 212 may be disposed at a middle location in a direction of the long edge of the substrate 210, so that the metasurface radiator 213 may be disposed on both sides of the feed patch 212 in the vertical direction, and sizes of patch elements located on two sides of the feed patch 212 may be different. When there is one feed patch 212, the antenna element may be equivalent to two conventional antenna elements in the vertical direction. For example, as described above, sizes and areas of metasurface radiators in regions on two sides of the feed patch 212 may be adjusted and controlled, so that a radiation pattern of the antenna element is equivalent to radiation patterns of the two conventional antenna elements.

When the size of the long edge of the substrate 210 is large, a quantity of feed patches 212 may also be correspondingly increased. For example, two feed patches 212 shown in FIG. 7B may be included. For a structure of the substrate 210 shown in FIG. 7B, refer to the structure of the substrate 210 described in FIG. 2 or FIG. 5. Details are not described herein again. When there are two feed patches 212 and the two feed patches 212 are disposed on the substrate 210 in the vertical direction, the antenna element may be equivalent to conventional antennas of three feed elements in the vertical direction.

The substrate 210 shown in FIG. 7C includes three feed patches 212. Correspondingly, the feed network 211 is located in two parts of the first region 214 in an x-axis direction, each part may include three second parts 2112, and the three second parts 2112 are electrically connected to the three feed patches 212 respectively. When there are three feed patches 212, there may be a distance between two adjacent feed patches 212, to dispose the metasurface radiator 213. For example, the feed patches 212 from above the y-axis to below the y-axis may be successively a feed patch 212A, a feed patch 212B, and a feed patch 212C. The feed patch 212B may be disposed on a symmetry axis that is of the substrate 210 and that is parallel to the x-axis direction. Distances from the feed patch 212A and the feed patch 212C to the feed patch 212B may be the same or may be different. Sizes of the metasurface radiators 213 located on two sides of the feed patch 212A and the feed patch 212C in the y-axis direction may be different, sizes of the metasurface radiators 213 located on two sides of the feed patch 212B in the y-axis direction may be the same, and sizes of the metasurface radiators 213 disposed at two ends of the substrate 210 in the y-axis direction may be the same. Alternatively, sizes of the metasurface radiators 213 located in different regions shown in FIG. 7C may be the same or may be different. When the antenna element includes three feed patches 212, the antenna element may be equivalent to antennas with four conventional feed elements or even five conventional feed elements in the vertical direction.

In an actual application scenario of the antenna element, a size of the antenna element and a quantity of feed patches 212 in the vertical direction may be designed and adjusted based on an arraying form or required radiation effect. When the antenna element includes a plurality of feed patches 212, there may still be one or two feed networks 211, so that a structure of the feed network can be greatly simplified and an overall structure of the antenna element can be further simplified on the premise that radiation effect that is the same as or similar to that of a conventional antenna element with more feed points is implemented.

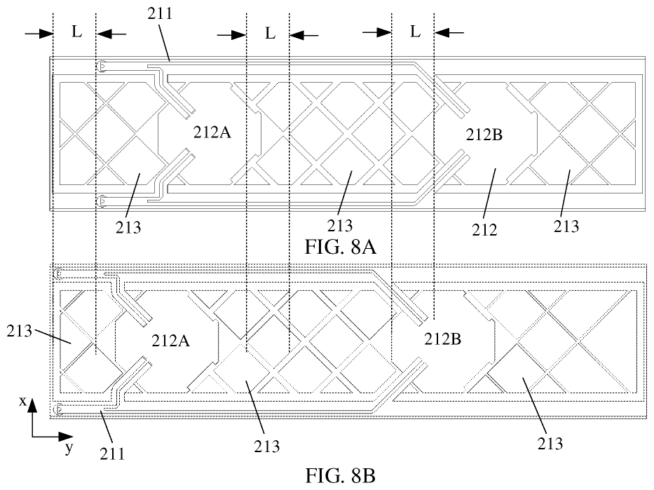

FIG. 8A and FIG. 8B are diagrams of a top view of a structure of another substrate 210 according to an embodiment of this application. An overall structure of the feed patch 212, the metasurface radiator 213, and the feed network 211 may be offset. FIG. 8A may be the substrate structure shown in FIG. 6, and FIG. 8B may be obtained by collectively offsetting the feed patch 212, the metasurface radiator 213, and the feed network 211 shown in FIG. 8A. The feed network 211 may be offset from a location shown in FIG. 8A by a distance L in a negative direction of a y-axis. Correspondingly, each feed patch 212 may also be offset from a location shown in FIG. 8A by the distance L in the negative direction of the y-axis. Each patch element of the metasurface radiator 213 may also be offset from a location shown in FIG. 8A by the distance L in the negative direction of the y-axis. The overall structure of the feed patch 212, the metasurface radiator 213, and the feed network 211 shown in FIG. 8A and FIG. 8B is offset in the negative direction of the y-axis. The overall structure of the feed patch 212, the metasurface radiator 213, and the feed network 211 may also be offset in a positive direction of the y-axis. An offset direction and a distance are not limited in this application. The overall structure of the feed patch 212, the metasurface radiator 213, and the feed network 211 are shifted, to assist in implementing beam deflection.

In the antenna elements described in FIG. 2 to FIG. 8A and FIG. 8B, the first region 214 in which the feed patch 212 and the metasurface radiator 213 are located may be symmetric. In other words, a symmetry axis of the first region 214 may be parallel to the direction of the y-axis shown in the figure, and the symmetry axis that is of the first region 214 and that is parallel to the direction of the y-axis may also be a symmetry axis that is of the substrate 210 and that is parallel to the direction of the y-axis. Alternatively, the first region 214 may not be vertically symmetrical. For example, the first region 214 may be obtained after the metasurface radiator and the feed patch shown in FIG. 2 to FIG. 7A, FIG. 7B, and FIG. 7C are completely offset in the x-axis direction shown in the figure. Overall symmetry of the first region 214 or the antenna element is not limited in this application.

The foregoing describes structures of the feed patch 212, the metasurface radiator 213, and the feed network 211 on the substrate 210 with reference to FIG. 2 to FIG. 8A and FIG. 8B. The following describes the metal back cavity 220 structure of the antenna element. A structure of the metal back cavity 220 may be the structure shown in FIG. 2, and the metal back cavity 220 may be a semi-open frame structure. For example, the metal back cavity 220 may include a bottom plate 221 and a side wall 222. The bottom plate 221 may also be referred to as a first metal plate. The side wall 222 may be disposed around a periphery of the bottom plate 221. The side wall 222 may include a first side wall 222A and a second side wall 222B. The first side wall 222A may be a side wall corresponding to a long edge of the metal back cavity 220, that is, a side wall disposed in a y-axis direction shown in the figure. The second side wall 222B may be a side wall corresponding to a short edge of the metal back cavity 220, that is, a side wall disposed in an x-axis direction shown in the figure.

The metal back cavity 220 may further include a second metal plate 223, and the second metal plate 223 may be disposed on an inner edge of the metal back cavity 220 in the vertical direction. In other words, one side of the second metal plate 223 may be fastened to the first side wall 222A. The second metal plate 223 may be disposed in a suspended manner on an inner edge of the first side wall 222A, or a distance may exist between the second metal plate 223 and the bottom plate 221 in a z-axis direction. When the substrate 210 is disposed in the metal back cavity 220, the second metal plate 223 may form a grounding structure of the feed network 211. When the feed network 211 is disposed on a surface that is of the substrate 210 and that faces the metal back cavity 220, the second metal plate 223 and the feed network 211 may jointly form an air-suspended microstrip line structure, and the second metal plate 223 and the feed network 211 jointly form an air-suspended microstrip line, so that a transmission loss of the feed network 211 can be reduced.

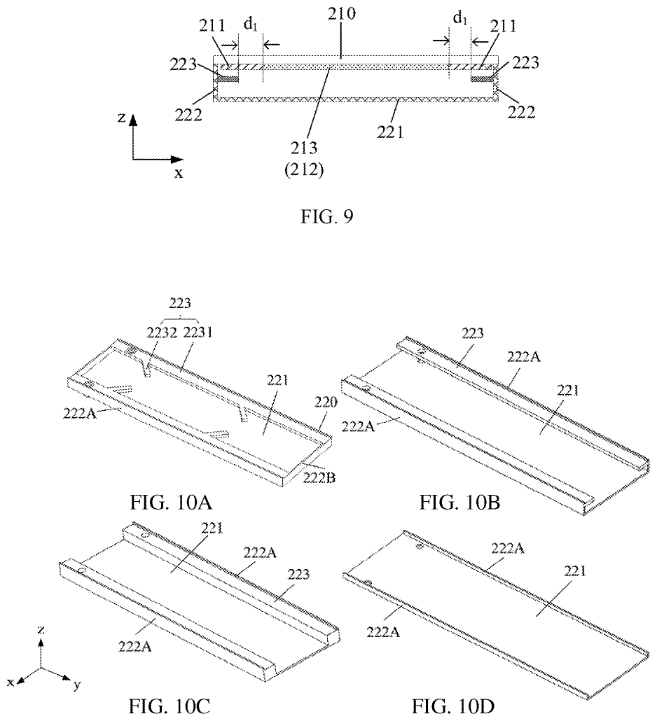

FIG. 9 is a side view of a structure of the antenna element. As shown in FIG. 9, there is a third gap between the first region 214 and the metal back cavity 220 in the horizontal direction. When the metal back cavity 220 includes the second metal plate 223, the third gap may be a gap between the first region 214 and the second metal plate 223 in an x-axis direction, that is, a gap di shown in the figure. The third gap exists between the first region 214 and the metal back cavity 220 in the horizontal direction, to adjust cross polarization discrimination (XPD) of the antenna element.

A gap may also exist between the first region 214 and the metal back cavity 220 in the vertical direction, for example, may be referred to as a fourth gap. Alternatively, the fourth gap may be a gap between the first region 214 and the second side wall 222B in the y-axis direction. For the fourth gap, refer to a distance de marked in FIG. 6. The fourth gap exists between the first region 214 and the metal back cavity 220 in the vertical direction, to adjust cross polarization discrimination of the antenna element.

FIG. 10A, FIG. 10B, FIG. 10C, and FIG. 10D are diagrams of a three-dimensional structure of the metal back cavity 220. As shown in FIG. 10A, the second metal plate 223 may include a main part 2231 and an extension part 2232. The main part 2231 is a part disposed at an inner edge of the first side wall 222A. The extension part 2232 may extend from a location connected to the main part 2231 to a center of the metal back cavity 220, and the extension part 2232 and the main part 2231 may be disposed at an included angle, for example, a 45° included angle. The main part 2231 and the extension part 2232 may be located in a same plane. For example, the plane in which the main part 2231 and the extension part 2232 are located may be parallel to an xy plane shown in the figure. When the substrate 210 is disposed in the metal back cavity 220, the second part 2112 of the feed network 211 may be disposed above the extension part 2232. In other words, the main part 2231 may form a grounding structure of the first part 2111 of the feed network 211, and the extension part 2232 may form a grounding structure of the second part 2112 of the feed network 211. When the second metal plate 223 is disposed in a suspended manner, that is, when the main part 2231 of the second metal plate 223 is disposed in a suspended manner, the extension part 2232 may also be disposed in a suspended manner, or there may be a distance between the extension part 2232 and the bottom plate 221 of the metal back cavity 220 in the z-axis direction. The second metal plate 223 includes the main part 2231 and the extension part 2232, so that a shape of the second metal plate 223 adapts to a shape of the feed network 211, and impedance matching is easily implemented.

It should be noted that, the main part 2231 and the extension part 2232 of the second metal plate 223 shown in the figure are located on a same plane to form a planar structure, and are parallel to the xy plane shown in the figure. The second metal plate 223 may alternatively be disposed at an included angle with the xy plane shown in the figure, or may be in another structure shape such as a curved surface, provided that the second metal plate 223 is not directly electrically connected to the feed network 211, and can form a grounding structure of the feed network 211. A width of the main part 2231 of the second metal plate 223 may be greater than a width of the first part 2111 of the feed network 211, and a width of the extension part 2232 of the second metal plate 223 may be greater than a width of the second part 2112 of the feed network 211. The width of the main part 2231 may be a size of the main part 2231 in the x-axis direction. The width of the first part 2111 may be a size of the first part 2111 in the x-axis direction. The width of the extension part 2232 may be a size of the extension part 2232 in a direction perpendicular to an extension direction. The width of the second part 2112 may be a size of the second part 2112 in the direction perpendicular to the extension direction. The width of the main part 2231 may also be less than the width of the first part 2111, the width of the extension part 2232 may also be less than the width of the second part 2112, and a length of the extension part 2232 may be the same as a length of the second part 2112, or may be greater than or less than a length of the second part 2112. A size of the second metal plate 223 is not limited in this application. When the feed network 211 includes two parts located above and below the first region 214, there may be two second metal plates 223, to respectively form grounding structures of the two parts of the feed network 211. When the feed network 211 includes only a part above the first region 214 or includes only a part below the first region 214, there may be two or one second metal plate 223, and one second metal plate 223 may be disposed on a side corresponding to the feed network 211.

Alternatively, the metal back cavity 220 may include only the first side wall 222A, and does not include the second side wall 222B, as shown in FIG. 10B. The second metal plate 223 may be fastened to only the first side wall 222A, and does not need to be fastened to the second side wall 222B. When the metal back cavity 220 does not include the second side wall 222B, the fourth gap may be a gap between the first region 214 and the bottom plate 221 in the y-axis direction, or a projection of the first region 214 on the bottom plate 221 in the direction perpendicular to the bottom plate 221 may be located in a region in which the bottom plate 221 is located.

The second metal plate 223 may alternatively be a solid layer, as shown in FIG. 10C. That is, the main part 2231 of the second metal plate 223 may be a solid layer, and there may be no distance between the main part 2231 of the second metal plate 223 and the bottom plate 221 of the metal back cavity 220, and the main part 2231 is directly connected to the bottom plate 221. In this example, when the second metal plate 223 includes the extension part 2232, the extension part 2232 may also be a solid layer, that is, there may be no distance between the extension part 2232 and the bottom plate 221 in the z-axis direction. When the main part 2231 of the second metal plate 223 is a solid layer, a recess (not shown in the figure) may also be provided at a location corresponding to the second metal plate 223 on a surface that is of the metal back cavity 220 and that is away from the substrate 210, to reduce an overall weight of the antenna element.

Alternatively, the second metal plate 223 may not be additionally disposed in the metal back cavity 220, as shown in FIG. 10D. When a height of the metal back cavity 220 is small, for example, when the height of the metal back cavity 220 is less than or equal to 1 mm, the metal back cavity 220 may not include the second metal plate 223. The height of the metal back cavity 220 is a size of the metal back cavity 220 in the z-axis direction. In an example, when the substrate 210 is disposed on the metal back cavity 220, the bottom plate 221 of the metal back cavity 220 may be used as a grounding structure of the feed network 211, and an air-suspended microstrip line may be formed between the feed network 211 and the bottom plate 221, to further simplify a structure of the antenna element. When the second metal plate 223 is not additionally disposed in the metal back cavity 220, the fourth gap may be a gap between the first region 214 and the first side wall 222A.

The antenna element provided in this embodiment of this application may be an asymmetric antenna, that is, a cross section shape of the antenna element along the xy plane may be a rectangle. A first edge length of the antenna element may be greater than or equal to an operating wavelength of the antenna element. When the antenna element is an asymmetric antenna element, the first edge length may be an edge length of an edge with a larger size of the antenna element, that is, an edge length of the first edge. The first edge length of the antenna element is greater than or equal to the operating wavelength of the antenna element, so that a beam width of the antenna element in the vertical direction can be adjusted, and good cross polarization discrimination of the antenna element can be maintained.

A second edge length of the antenna element may be less than or equal to a half of the operating wavelength of the antenna element. When the antenna element is an asymmetric antenna element, the second edge length may be an edge length of an edge with a smaller size of the antenna element. The second edge length is less than or equal to a half of the operating wavelength of the antenna element, so that a beam width of the antenna element in the horizontal direction can be adjusted, and good cross polarization discrimination of the antenna element can be maintained, and arraying of the antenna element in the horizontal direction can be further facilitated.

An embodiment of this application further provides a communication device. The communication device may include one or more antenna elements described in the foregoing embodiment. When there are a plurality of antenna elements, the plurality of antenna elements may form an antenna array. For example, the plurality of antenna elements may be arranged in an array in an x direction.

An embodiment of this application further provides an antenna system. The antenna system may include one or more antenna elements described in the foregoing embodiment.

An embodiment of this application further provides a base station, and the base station may include the foregoing antenna system.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1.-20. (canceled)

21. An antenna element, comprising:
a substrate, wherein a feed network, a feed patch, and a metasurface radiator are on the substrate, the feed patch and the metasurface radiator are located in a first region, and the feed network is connected to the feed patch; and
a metal structure defining a cavity, wherein the substrate is disposed in the cavity.

22. The antenna element according to claim 21, wherein the feed network being connected to the feed patch comprises:
at least a part of the feed network is located in the first region, and the part that is of the feed network and that is located in the first region is connected to the feed patch.

23. The antenna element according to claim 21, wherein the feed network, the feed patch, and the metasurface radiator are disposed on a same surface of the substrate.

24. The antenna element according to claim 21, wherein the feed network, the feed patch, and the metasurface radiator are disposed on a surface that is of the substrate and that faces into the cavity.

25. The antenna element according to claim 21, wherein the metasurface radiator comprises a plurality of patch elements, and a projected area of the feed patch in a direction perpendicular to the substrate is different from a projected area of each of the plurality of patch elements in the direction perpendicular to the substrate.

26. The antenna element according to claim 21, wherein the metasurface radiator comprises a plurality of first patch elements and a plurality of second patch elements, the plurality of first patch elements and the plurality of second patch elements are respectively disposed in regions on two sides of the feed patch in the first region, and a projected area of any one of the plurality of first patch elements in the direction perpendicular to the substrate is different from a projected area of any one of the plurality of second patch elements in the direction perpendicular to the substrate.

27. The antenna element according to claim 26, wherein the plurality of first patch elements and the plurality of second patch elements are respectively disposed in regions on two sides of the feed patch in a direction of a first edge of the antenna element.

28. The antenna element according to claim 21, wherein the metasurface radiator comprises a plurality of patch elements, the plurality of patch elements are distributed in different regions on the substrate, and a first gap is between the feed patch and at least one adjacent patch element.

29. The antenna element according to claim 28, wherein widths of first gaps between the feed patch and patch elements located in regions on two sides of the feed patch are different.

30. The antenna element according to claim 28, wherein the metasurface radiator comprises a plurality of patch elements, and a second gap is between at least two adjacent patch elements in the plurality of patch elements.

31. The antenna element according to claim 30, wherein widths of second gaps of patch elements located in regions on two sides of the feed patch are different.

32. The antenna element according to claim 30, wherein a width of the first gap is different from a width of the second gap.

33. The antenna element according to claim 21, wherein the metal structure comprises a first metal plate, the first metal plate is a bottom plate of the metal structure, and the first metal plate is a grounding structure of the feed network.

34. The antenna element according to claim 21, wherein the metal structure comprises a first metal plate and a second metal plate, the first metal plate is a bottom plate of the metal structure, the second metal plate is fastened to the first metal plate, and the second metal plate is a grounding structure of the feed network.

35. The antenna element according to claim 34, wherein the second metal plate comprises a main part and an extension part, the main part is fastened to the metal structure, and the extension part and the main part are disposed at an included angle.

36. The antenna element according to claim 21, wherein a gap is between the first region and the metal structure.

37. The antenna element according to claim 21, wherein one or more feed patches are comprised in the antenna element, and the one or more feed patches are disposed on a same surface of the substrate in the direction of a first edge of the antenna element.

38. The antenna element according to claim 21, wherein an edge of the feed patch comprises an opening part, or the feed patch is in a truncated-corner structure.

39. The antenna element according to claim 21, wherein a length of a first edge of the antenna element is greater than or equal to an operating wavelength of the antenna element.

40. A communication device, comprising:
one or more antenna elements, wherein a first antenna element of the one or more antenna elements comprises:
a substrate, wherein a feed network, a feed patch, and a metasurface radiator are on the substrate, the feed patch and the metasurface radiator are located in a first region, and the feed network is connected to the feed patch; and
a metal structure defining a cavity, wherein the substrate is disposed in the cavity.
